(19) United States
(12) Patent Application Publication
(10) Pub. No.: US 2006/0285629 A1
(43) Pub. Date: Dec. 21, 2006

(54) Fuel assembly for a pressurized water nuclear reactor

(75) Inventors: Jurgen Stabel, Erlangen (DE); Veit Marx, Erlangen (DE)

Correspondence Address: LERNER GREENBERG STEMER LLP, P O BOX 2480, HOLLYWOOD, FL, 33022-2480, US

(73) Assignee: Framatome ANP GmbH

(21) Appl. No.: 11/343,041

(22) Filed: Jan. 30, 2006

Related U.S. Application Data
(63) Continuation of application No. PCT/EP04/08041, filed on Jul. 19, 2004.

(30) Foreign Application Priority Data
Jul. 28, 2003 (DE) 103 34 580.9

(51) Int. Cl. G21C 3/34

(52) U.S. Cl. 376/438

(57) ABSTRACT

A fuel assembly for a compressed water nuclear reactor contains a plurality of fuel rods that are guided into a plurality of axially interspaced spacers respectively forming a quadratic grid formed of connecting elements and containing a plurality of holes that are disposed in rows and columns. A control rod guiding tube is respectively guided through a number of the holes, and the spacer is structurally embodied in such a way that when a limiting force acting laterally on the spacer is exceeded, a deformation is triggered exclusively in a region of the spacer located outside an inner region containing the control rod guiding tubes.

### CROSS REFERENCE TO RELATED APPLICATION

This is a continuing application, under 35 U.S.C. §120, of copending international application No. PCT/EP2004/008041, filed Jul. 19, 2004, which designated the United States; this application also claims the priority, under 35 U.S.C. §119, of German patent application No. 103 34 580.9, filed Jul. 28, 2003; the prior applications are herewith incorporated by reference in their entirety.

### BACKGROUND OF THE INVENTION

### Field of the Invention

The invention relates to a fuel assembly for a pressurized water nuclear reactor, as disclosed for example by German Patent DE 196 35 927 C1, corresponding to U.S. Pat. No. 6,167,104. Such a fuel assembly is illustrated by way of example in FIG. 5. In such a fuel assembly, a multiplicity of fuel rods are guided mutually parallel in the rod direction (axially) by a plurality of spacers mutually separated axially, which respectively form a two-dimensional grid with a multiplicity of mesh cells, which are disposed in columns and rows. Besides the fuel rods, support tubes which do not contain fuel and are intended to hold and guide control rods (so-called control rod guide tubes), are also guided through the mesh cells of the grid. There may furthermore be support tubes which likewise do not contain fuel and are merely used to increase the stability (instrumentation tubes or structure tubes, neither instrumentation tubes nor structure tubes being provided in the fuel assembly represented by way of example). Unlike the fuel rods in the mesh cells, the support tubes are welded to the spacers so that their stabilizing effect is ensured over the entire working life of the fuel assembly.

Forces act on the fuel assemblies during operation, and may lead to bending of the fuel assemblies. In order to avoid or limit such bending, without substantially impairing the neutron economy, the use of spacers in which some of the grid struts are formed of steel is known from U.S. Pat. No. 4,325,786.

In the event of hypothetical external accidents, for example in the event of an earthquake or loss of coolant with a large break (LOCA—Loss Of Coolant Accident), the spacers may experience a significant shock load due to the neighboring fuel assemblies. The permanent deformations then occurring, which generally become noticeable as kinks of individual rows or columns, must not exceed maximum permissible values in order to ensure that the control rods can still be inserted into the control rod guide tubes, so as to allow safe further operation or a safe shutdown of the plant. While plastic deformations are in principle allowed to a limited extent, it is consequently necessary to avoid pronounced buckling which leads to a significant offset of the control rod guide tubes disposed in the fuel assembly. To this end, for example, provision of the peripheral bars of the spacers with outwardly extending protuberances which absorb transverse forces before they affect the grid bars lying on the inside is known from U.S. Pat. No. 5,307,302.

The spacers are accordingly configured so that the expected impact loads do not lead to pronounced buckling or kinking of the spacers. A development goal which is aimed for in practice is a buckling strength of about 20 kN for fresh unirradiated spacers (BOL (=Begin Of Life) spacers). For BOL spacers, therefore the impact load occurring in the scope of an accident (earthquake, LOCA) and can be absorbed so long as it is less than 20 kN.

Nevertheless, particularly in the case of spacers which have been in use for a prolonged time and are approaching the end of their working life (EOL (=End Of Life), forces may occur in unfavorable situations which are greater than their buckling strength, since this can become reduced significantly compared with new spacers. This reduction of the buckling strength depends on the respective type of spacer, and can amount to more than 50 to 60%.

### SUMMARY OF THE INVENTION

It is accordingly an object of the invention to provide a fuel assembly for a pressurized water nuclear reactor which overcomes the above-mentioned disadvantages of the prior art devices of this general type, in which the insertability of the control rods is improved compared with the known fuel assemblies even following the effect of transverse forces which exceed the buckling strength of the spacers, i.e. after irreversible plastic deformation has taken place.

With the foregoing and other objects in view there is provided, in accordance with the invention, a fuel assembly for a pressurized water nuclear reactor. The fuel assembly contains control rod guide tubes, and a multiplicity of axially separated spacers. The spacers each form a square grid constructed from grid bars disposed in rows and columns and define a multiplicity of mesh cells and an inner region. The control rod guide tubes are respectively fed through a number of the mesh cells disposed in the inner region. The spacers are constructed so that when a threshold force acting laterally on a respective one of the spacers is exceeded, a deformation begins exclusively in a region of the respective spacer lying outside the inner region containing the control rod guide tubes. A multiplicity of fuel rods are guided in the multiplicity of axially separated spacers.

According to these features, in the fuel assembly for the pressurized water nuclear reactor which contains a multiplicity of fuel rods guided in a multiplicity of axially separated spacers, which respectively form a square grid constructed from grid bars with a multiplicity of mesh cells, which are arranged in rows and columns, and in which a support tube (control rod guide tube or structure tube) is respectively fed through a number of these mesh cells, it is proposed that the spacer should be constructively configured so that when a threshold force acting laterally on the spacer is exceeded, a deformation begins exclusively i.e. systematically due to the mechanical configuration in a region of the spacer lying outside an inner region containing the control rod guide tubes.

This measure ensures that the inner region experiences no deformation, or at worst negligible deformation, even if the buckling threshold is exceeded, so that the control rod guide tubes which lie exclusively in the inner region maintain their relative positions even if the spacers are deformed, and the mobility of the control rods is improved.

The invention is based on the discovery that integrity can be ensured for the inner region, which is critical for the mobility of the control rods, even in the event of progressive deformation by inducing the onset of the deformation (buckling or kinking) in a controlled way at the edge of the spacer, since the plastic deformation initially progresses only in the regions where it begins.

FIGS. 6 and 7 respectively show schematic representations of a conventional spacer 4a, a spacer with 17×17 mesh cells 6 in the example, on whose opposing side edges a pressure force F greater than the kinking or buckling threshold F_{crit} has been exerted perpendicularly to rows 10 (parallel to the columns 8). For the corresponding laboratory tests, support tube sections that extend beyond the spacer 4 by about 10 mm on both sides were welded into the spacer 4 at positions Pₐ where the control rod guide tubes 12 are located in the fuel assembly. In order to be able to assess the EOL buckling strength, either the spacer 4 was thermally relaxed and each support tube-free mesh cell 6 was occupied by sections of fuel rod casing tubes, which belong to the respective type of spacer, or sections with a slightly smaller external diameter were used instead of the casing tube sections normally provided for this type of spacer tube, so as to simulate the relaxation of the spacer 4. The casing tube sections used also protrude beyond the spacer 4 and simulate the fuel rods spring mounted in the mesh cells through which control rod guide tubes do not pass in the fully configured fuel assembly.

It can now be seen from FIG. 6, for example, that shear-like buckling or kinking of two central rows 10₁₀, 10₁₁ takes place when the buckling threshold F_{crit} is reached. Increasing the transverse force F can lead to kinking of further rows 101, 10₂, 10₇, 10₈, 10₁₆ and 10₁₇, as illustrated in FIG. 7.

FIGS. 6 and 7 also show that the buckling first takes place in the rows 10 which do not contain a support tube section firmly welded to the spacer 4 (support tube-free row).

A similar situation is shown according to FIG. 8 for a conventional 16×16 spacer 4b, in which the buckling likewise occurs in the support or control rod guide tube-free central rows 10₈, 10₉.

The invention is then based on the observation that central buckling is much more problematic than buckling at the edge, since the former leads to a mutual offset of the control rod guide tubes, as can readily be seen with the aid of FIGS. 6-8.

Based on this observation, the invention now uses the idea that by controlled construction measures, especially by controlled weaker construction of the edge zones of the spacer which lie outside the inner region, it is possible to shift the start of the deformation systematically into them. In this way, the integrity of the inner region is preserved even when deformation occurs.

The mesh cells of the spacer are preferably formed by peripheral grid bars disposed at the edge and inner grid bars lying on the inside, and the term grid bar may refer either to the peripheral grid bars or to the inner grid bars in what follows. The edge zone where such mechanical weakening is carried out is then formed by the inner grid bars lying outside the inner region, the ends protruding from the inner region on the inner grid bars which cross the inner region, and the peripheral grid bars.

In a preferred embodiment, at least one inner grid bar crossing the inner region has a higher strength than at least one inner grid bar outside the inner region.

The grid bars are preferably joined to one another by welded connections, at least some of the welded connections of the inner grid bars outside the inner region have a lower strength than welded connections lying inside the inner region.

In a preferred embodiment of the invention, at least some of the inner grid bars are materially weakened, in a bar region lying outside the inner region, relative to the bar regions disposed inside the inner region, the material weakening being induced particularly by a smaller wall thickness (bar width) of these inner grid bars or by recesses deliberately introduced into the bars to weaken them.

Other features which are considered as characteristic for the invention are set forth in the appended claims.

Although the invention is illustrated and described herein as embodied in a fuel assembly for a pressurized water nuclear reactor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1 and 2 are diagrammatic, plan views of a spacer according to the invention after a deformation test has been carried out;

FIG. 3 is a diagrammatic, detailed perspective view of the spacer in an edge region in which various measures according to the invention for controlled weakening in the edge region are schematically illustrated;

FIG. 4 is a diagrammatic, plan view of a second embodiment of the spacer according to the invention, likewise after a deformation test has been carried out;

FIG. 5 is a diagrammatic, perspective view of a fuel assembly for a pressurized water nuclear reactor, as is known in the prior art; and

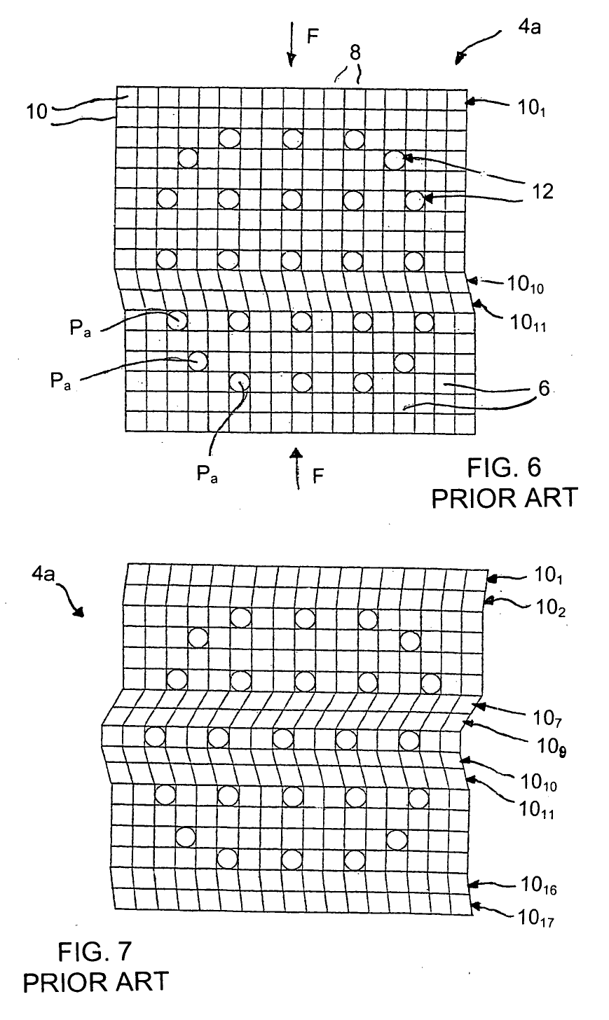

FIGS. 6-8 are diagrammatic, plan view of a known spacer after a deformation test has been carried out.

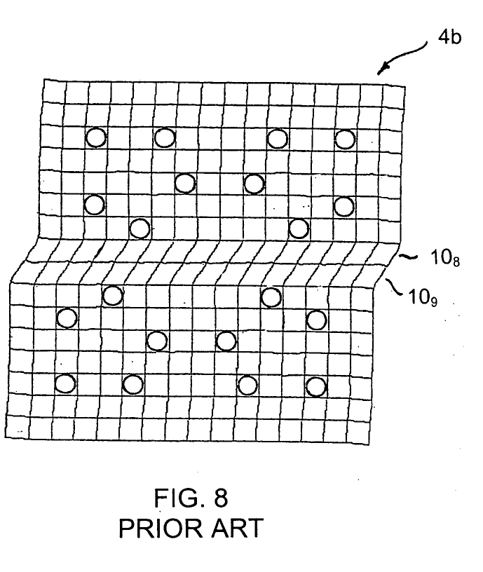

### DESCRIPTION OF THE PREFERRED EMBODIMENTS

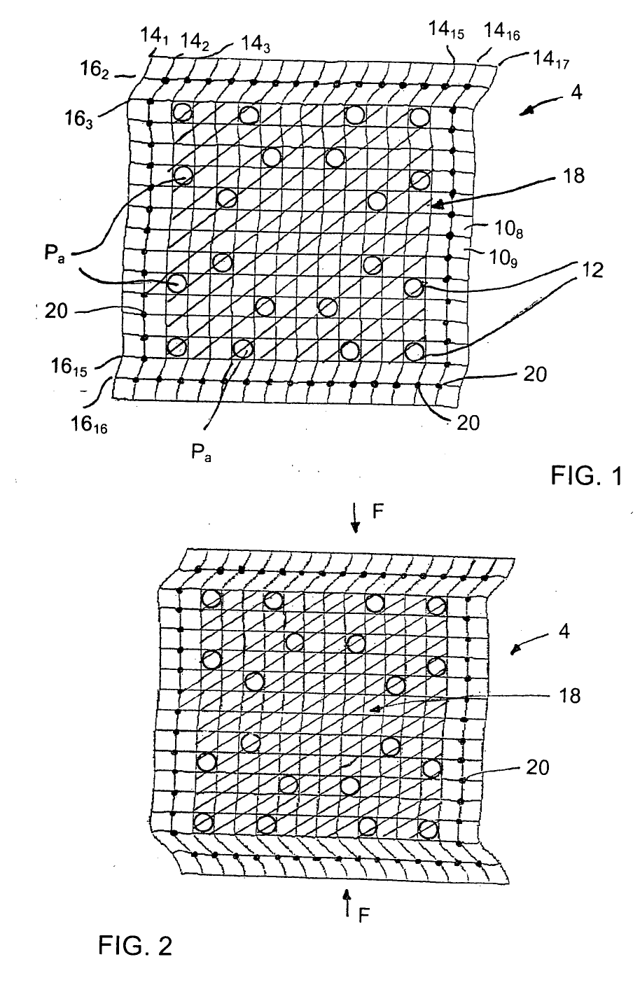

Referring now to the figures of the drawing in detail and first, particularly, to FIG. 1 thereof, there is shown a 16×16 spacer 4 with a configuration of support tubes in positions Pₐ, as is also found in the known spacer represented in FIG. 8.

In the exemplary embodiment, all the support tubes are control rod guide tubes 12. There are no other structure tubes in this exemplary embodiment.

The spacer 4 is constructed from grid bars 14₁,-14₁₇, and 16₁-16₁₇ which are welded to one another at crossing points. The grid bars 14₁, 14₁₇, 16₁ and 16₁₇ form the edge of the grid and will be referred to below as peripheral grid bars. The grid bars 14₂-14₁₆ and 16₂-16₁₆ extend inside the grid and will be referred to below as inner grid bars.

The control rod guide tubes 12 define an inner region 18 highlighted by shading, which is formed in the exemplary embodiment by a square zone bounded by the inner grid bars 14₃, 14₁₅, 16₃ and 16₁₅ and which contains the inner grid bars 14₃, 14₁₅, 16₃ and 16₁₅. With the aid of the positions marked by black dots, FIG. 1 illustrates the fact that welded connections 20, located outside the inner region 18, of the grid bars 14₂, 14₁₆, 16₂, 16₁₆ respectively to the intersecting grid bars 16₂₋₁₆ and 14₂₋₁₆, are weakened relative to the other welding positions 20. This may be done by reducing the welding length, a diameter of the welding spot or the number of welding positions.

The effect of this controlled weakening of the spacer 4 in the edge region, when a transverse force exceeding a threshold force (buckling or kinking threshold F_{crit}) is exerted, is that kinking no longer takes place in the rows 10₈ and 10₉ as in FIG. 8 but in the rows 10₁, 10₂, 10₁₅ and 10₁₆ lying outside the inner region 18. A direct comparison of the situations respectively represented in FIGS. 1 and 8 shows that the configuration of the control rod guide tubes 12 (in the example, all the support tubes are control rod guide tubes) remains virtually unchanged even after the kinking in the exemplary embodiment according to FIG. 1, so that the mobility of the control rods is not hindered, or is hindered to a much lesser extent than in the situation represented by FIG. 8.

In principle, the welded connections of the peripheral grid bars to one another and to the inner grid bars may additionally or alternatively be subjected to controlled weakening. However, it has been found that the weakening carried out only on the inner grid bars in the exemplary embodiment is particularly advantageous.

FIG. 2 shows the spacer 4 according to FIG. 1 after having carried out a deformation test in which, in contrast to the situation represented in FIG. 1, gliding has been prevented on one of the side faces between which the force F>F_{crit} is exerted. It can be seen from FIG. 2 that, in this case, a deformation occurs which is mirror-symmetric as opposed to the point-symmetric deformation according to FIG. 1. The integrity of the inner region 18 is preserved in this case as well.

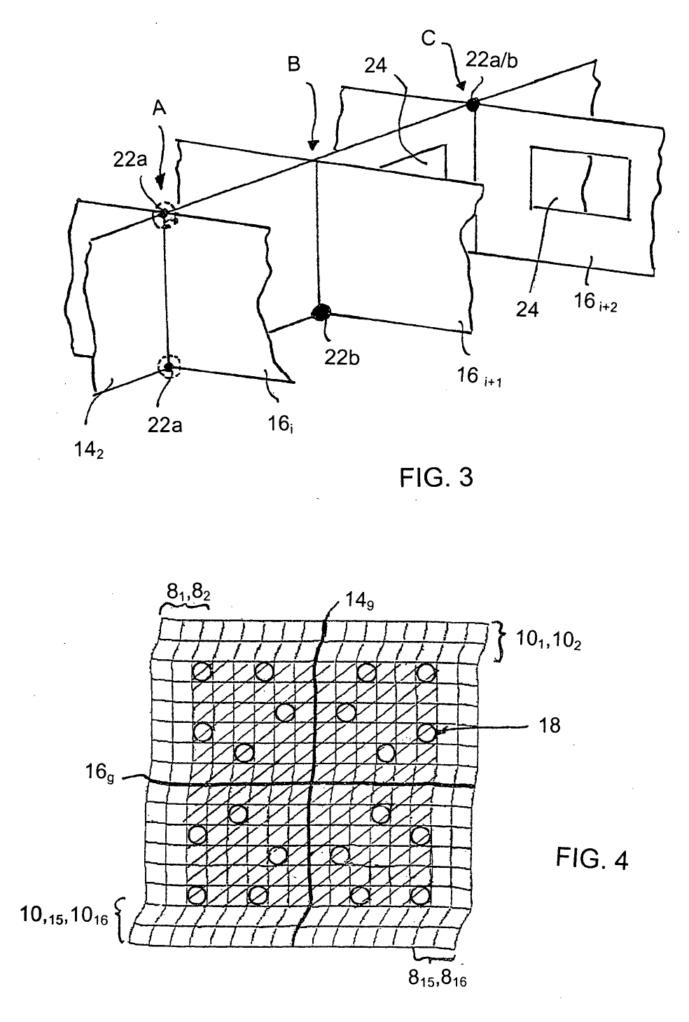

FIG. 3 illustrates an inner grid bar disposed outside the inner region, for example the grid bar 143 with inner grid bars 16_{i,i+1,i+3} intersecting it, in a perspective detail. FIG. 3 explains by way of example, and not exhaustively, various ways in which controlled weakening of the spacer 4 in the edge region can be achieved in practice. The example represents a spacer in which the grid bars 14₂, 16_{i,i+1,i+3} are joined to one another by welding spots 22a, 22b.

One way of inducing controlled weakening is then to use welding spots 22a whose diameter is reduced compared with the diameter of the welding spots 22b used in the inner region, and which are represented by dashes in FIG. 3, but without reducing their number per crossing point (crossing point A).

In an alternative embodiment, the number of welding spots 22b per crossing point is reduced, although they are configured in the same way as the welding spots in the inner region (crossing point B).

Controlled weakening may also be carried out by introducing recesses 24 into the inner grid bars 14₂, 16_{i,i+1,i+3} in their bar regions lying outside the inner region 18 (crossing point C).

In principle, as an alternative or in addition to this, it is also possible to configure the grid bars 14_{2,16}, 16_{2,16} disposed outside the inner region 18 with a reduced wall thickness relative to the other grid bars (inner grid bars and outer grid bars).

The measures—reducing the diameter of the welding spots, reducing the number of welding spots, weakening the bar plates—may also be combined with one another. Furthermore, the measures may also be applied to the peripheral grid bars.

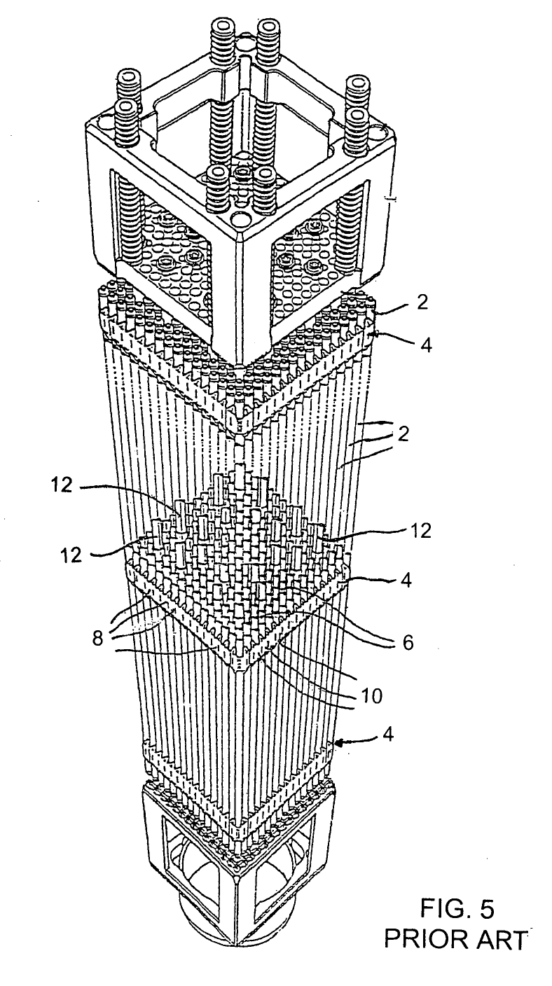

In the exemplary embodiment according to FIG. 4, instead of the controlled or active weakening of the edge zones 8_{1,2}, 8_{15,16}, 10_{1,2}, 10_{15,16} as represented in FIGS. 1 to 3, a relative weakening of these edge zones is induced by the fact that the inner grid bars 14₉ and 16₉ disposed in the middle have a larger wall thickness. Active direct weakening of the edge zone is thus not carried out in this exemplary embodiment, but instead it is indirectly weakened relative to the inner region 18 by the fact that at least one inner grid bar passing through the inner region 18, the central inner grid bars 14₉, 16₉ in the example for symmetry reasons, is configured to be thicker than the inner grid bars 14₁, 14₁₆, 16₁, 16₁₆ outside the inner region 18.

We claim:

1. A fuel assembly for a pressurized water nuclear reactor, comprising:
control rod guide tubes;
a multiplicity of axially separated spacers, said spacers each forming a square grid constructed from grid bars disposed in rows and columns and defining a multiplicity of mesh cells and an inner region, said control rod guide tubes being respectively fed through a number of said mesh cells disposed in said inner region, said spacers constructed so that when a threshold force acting laterally on a respective one of said spacers is exceeded, a deformation begins exclusively in a region of said respective spacer lying outside said inner region containing said control rod guide tubes; and
a multiplicity of fuel rods guided in said multiplicity of axially separated spacers.

2. The fuel assembly according to claim 1, wherein said spacers are mechanically weaker outside said inner region than inside said inner region.

3. The fuel assembly according to claim 1, wherein:
said grid bars include peripheral grid bars and inner grid bars; and
said mesh cells of said spacers are formed by said peripheral grid bars disposed at an edge and said inner grid bars lying inside.

4. The fuel assembly according to claim 3, wherein at least one of said inner grid bars crossing said inner region has a higher strength than at least one of said inner grid bars disposed outside said inner region.

5. The fuel assembly according to claim 3, wherein said grid bars are joined to one another by welded connections, at least some of said welded connections of said inner grid bars disposed outside said inner region having a lower strength than said welded connections lying inside said inner region.

6. The fuel assembly according to claim 3, wherein at least some of said inner grid bars are materially weakened in a bar region lying outside said inner region.

7. The fuel assembly according to claim 6, wherein said inner grid bars disposed outside said inner region have a smaller thickness than said inner grid bars crossing said inner region.

8. The fuel assembly according to claim 6, wherein at least one of said grid bars disposed outside said inner region has a recess formed therein for material weakening.

9. A spacer assembly for a fuel assembly of a pressurized water nuclear reactor, the fuel assembly having control rod guide tubes and a multiplicity of fuel rods, the spacer assembly comprising:
a multiplicity of axially separated spacers, said spacers each forming a square grid constructed from grid bars disposed in rows and columns and defining a multiplicity of mesh cells and an inner region, said mesh cells disposed in said inner region provided for receiving the control rod guide tubes, said spacers constructed so that when a threshold force acting laterally on a respective one of said spacers is exceeded, a deformation begins exclusively in a region of said respective spacer lying outside said inner region containing said control rod guide tubes, and said spacers further provided for receiving the multiplicity of fuel rods.
